(19) United States
(12) Patent Application Publication
(10) Pub. No.: US 2020/0286008 A1
(43) Pub. Date: Sep. 10, 2020

(54) SYSTEMS AND METHODS FOR DISTRIBUTING ON-DEMAND SERVICE REQUESTS

(71) Applicant: BEIJING DIDI INFINITY TECHNOLOGY AND DEVELOPMENT CO., LTD., Beijing (CN)

(72) Inventor: Jiawei SHEN, Beijing (CN)

(73) Assignee: BEIJING DIDI INFINITY TECHNOLOGY AND DEVELOPMENT CO., LTD., Beijing (CN)

(21) Appl. No.: 16/885,214

(22) Filed: May 27, 2020

Related U.S. Application Data
(63) Continuation of application No. PCT/CN2017/113047, filed on Nov. 27, 2017.

(51) Int. Cl. G06Q 10/04; G06Q 10/06; G06Q 10/02; G06Q 30/06; G06N 3/12; G08G 1/00

(52) U.S. Cl. CPC G06Q 10/04; G06Q 10/06311; G08G 1/202; G06Q 30/0635; G06N 3/126; G06Q 10/02

(57) ABSTRACT

The present disclosure relates to systems and methods for distributing a plurality of service requests associated with an on-demand service. The systems may perform the methods to obtain a plurality of service requests; determine one or more garages based on the plurality of service requests; determine one or more available service providers based on the plurality of service requests; determine a distribution mode for the plurality of service requests based on the one or more garages and the one or more available service provides according to a genetic algorithm; and distribute the plurality of service requests based on the distribution mode.

### CROSS-REFERENCE TO RELATED APPLICATIONS

This application is a continuation of International Application No. PCT/CN2017/113047, filed on Nov. 27, 2017, which designates the United States of America, the contents of which are incorporated herein by reference in their entirety.

### TECHNICAL FIELD

The present disclosure generally relates to systems and methods for on-demand services, and in particular, to systems and methods for distributing on-demand service requests based on a genetic algorithm.

### BACKGROUND

On-demand services utilizing Internet technology have become increasingly popular because of their convenience. Take a vehicle rental service as an example, after receiving a plurality of service requests, a system providing the services may determine one or more service providers to deliver vehicles from one or more garages to a plurality of delivery locations according to the service requests. It is desirable to provide systems and methods that can reduce the cost (e.g., a lower service time) and/or improve the efficiency of vehicle delivery to satisfy the plurality of service requests.

### SUMMARY

According to an aspect of the present disclosure, a system is provided. The system may include at least one storage medium and at least one processor in communication with the at least one storage medium. The at least one storage medium may include a set of instructions for distributing a plurality of service requests associated with an on-demand service. When the at least one storage medium executes the set of instructions, the at least one processor may be configured to cause the system to perform one or more of the following operations. The at least one processor may obtain a plurality of service requests. The at least one processor may determine one or more garages based on the plurality of service requests. The at least one processor may determine one or more available service providers based on the plurality of service requests. The at least one processor may determine a distribution mode for the plurality of service requests based on the one or more garages and the one or more available service providers according to a genetic algorithm. The at least one processor may distribute the plurality of service requests based on the distribution mode.

According to another aspect of the present disclosure, a method is provided. The method may be implemented on a computing device having at least one processor, at least one storage medium, and a communication platform connected to a network. The method may include one or more of the following operations. The at least one processor may obtain a plurality of service requests. The at least one processor may determine one or more garages based on the plurality of service requests. The at least one processor may determine one or more available service providers based on the plurality of service requests. The at least one processor may determine a distribution mode for the plurality of service requests based on the one or more garages and the one or more available service providers according to a genetic algorithm. The at least one processor may distribute the plurality of service requests based on the distribution mode.

According to yet another aspect of the present disclosure, a non-transitory computer-readable storage medium is provided. The non-transitory computer-readable storage medium may include a set of instructions for distributing a plurality of service requests associated with an on-demand service. When the set of instructions is executed by at least one processor, the set of instructions may direct the at least one processor to perform one or more of the following operations. The at least one processor may obtain a plurality of service requests. The at least one processor may determine one or more garages based on the plurality of service requests. The at least one processor may determine one or more available service providers based on the plurality of service requests. The at least one processor may determine a distribution mode for the plurality of service requests based on the one or more garages and the one or more available service providers according to a genetic algorithm. The at least one processor may distribute the plurality of service requests based on the distribution mode.

In some embodiments, the at least one processor may determine a plurality of preliminary distribution modes for the plurality of service requests based on the one or more garages and the plurality of available service providers. The at least one processor may determine a plurality of preliminary evaluation results associated with the plurality of preliminary distribution modes. The at least one processor may determine whether the plurality of preliminary evaluation results satisfy a stop condition. The at least one processor may determine the distribution mode based on the plurality of preliminary distribution modes in response to the determination that the plurality of preliminary evaluation results satisfy the stop condition.

In some embodiments, in response to the determination that the plurality of preliminary evaluation results does not satisfy the stop condition, the at least one processor may select one or more preliminary distribution modes from the plurality of preliminary distribution modes based on the plurality of preliminary evaluation results; determine one or more modified distribution modes by performing at least one of a crossover operation or a mutation operation on the remainder of the plurality of preliminary distribution modes other than the selected one or more preliminary distribution modes; and update the plurality of preliminary evaluation results associated with the selected one or more preliminary distribution modes and the one or more modified distribution modes.

In some embodiments, the stop condition may include a first condition that a number of iterations is larger than a first threshold, a second condition that a difference between a minimum value of the plurality of preliminary evaluation results and an average value of the plurality of preliminary evaluation results is less than a second threshold; and/or a third condition that the minimum value of the plurality of preliminary evaluation results is less than a third threshold.

In some embodiments, the at least one processor may determine a target function associated with the one or more garages and the one or more available service providers. The at least one processor may determine a constraint condition associated with the target function. The at least one processor may determine the plurality of preliminary evaluation results associated with the plurality of preliminary distribution modes based on the target function and the constraint condition.

In some embodiments, the one or more available service providers may include a first service provider available to provide services at a first time point when the plurality of service requests are processed for distribution.

In some embodiments, the one or more available service providers may include at least a second service provider available to provide services at a second time point, wherein the second time point is within a time range from a time point when the plurality of service requests are processed for distribution to one of a plurality of delivery times of the plurality of service requests.

In some embodiments, the at least one processor may determine a current location of a candidate service provider. The at least one processor may obtain a destination of a service that the candidate service provider is providing. The at least one processor may determine an estimated time of arrival (ETA) based on the current location and the destination. The at least one processor may determine a predicted time point based on the ETA. The at least one processor may determine the candidate service provider as the second service provider in response to the determination that the predicted time point is earlier than the one of the plurality of delivery times of the plurality of service requests.

In some embodiments, the service request may be a request for renting a vehicle, and wherein the request may include a delivery time, a delivery location, and/or a type of the vehicle.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating exemplary hardware and/or software components of a computing device according to some embodiments of the present disclosure;

FIG. 3 is a block diagram illustrating an exemplary processing engine according to some embodiments of the present disclosure;

FIG. 4 is a flowchart illustrating an exemplary process for distributing a plurality of service requests according to some embodiments of the present disclosure;

FIG. 5 is a flowchart illustrating an exemplary process for determining an available service provider according to some embodiments of the present disclosure;

FIG. 6 is a flowchart illustrating an exemplary process for determining a distribution mode for a plurality of service requests based on a genetic algorithm according to some embodiments of the present disclosure;

FIGS. 7-A and 7-B are schematic diagrams illustrating an exemplary preliminary distribution mode according to some embodiments of the present disclosure; and

FIG. 8 is a schematic diagram illustrating an exemplary process for determining a distribution mode for a plurality of service requests based on a genetic algorithm according to some embodiments of the present disclosure.

### DETAIL DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure, and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding on-demand transportation service, it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The terms “passenger,” “requestor,” “service requestor,” and “customer” in the present disclosure are used interchangeably to refer to an individual, an entity that may request or order a service. Also, the terms “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity that may request a service, order a service, provide a service, or facilitate the providing of the service. For example, the user may be a passenger, a driver, an operator, or the like, or any combination thereof. In the present disclosure, terms “passenger,” “user equipment,” “user terminal,” and “passenger terminal” may be used interchangeably, and terms “driver” and “driver terminal” may be used interchangeably.

The terms “request,” and “service request” in the present disclosure are used interchangeably to refer to a request that may be initiated by a passenger, a requestor, a service requestor, a customer, a driver, a provider, a service provider, a supplier, or the like, or any combination thereof. The service request may be accepted by any one of a passenger, a requestor, a service requestor, a customer, a driver, a provider, a service provider, or a supplier. The service request may be chargeable or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure relates to systems and methods for distributing a plurality of service requests (e.g., service requests for vehicle rental service). The systems and methods may determine a distribution mode and distribute the plurality of service requests based on the distribution mode. For example, the systems and methods may determine one or more garages and one or more available service providers based on the plurality of service requests (e.g., delivery locations, vehicle types, and/or delivery times included in the service requests). The systems and methods may further determine the distribute mode for the plurality of service requests based on the one or more garages and the one or more available service providers according to a genetic algorithm.

It should be noted that online on-demand transportation service (e.g., online vehicle rental), is a new form of service rooted only in post-Internet era. It provides technical solutions to users and service providers that could raise only in post-Internet era. In pre-Internet era, when a user wishes to rent a vehicle, the user should head to a vehicle rental company or call the vehicle rental company. Online vehicle rental, however, allows a user who wishes to rent a vehicle to initiate a service request to an online rental platform. The online rental platform operates and/or manages a plurality of garages and a plurality of service providers. After receiving a service request, the online rental platform may determine a garage and a service provider who will deliver a vehicle from the garage to a delivery location that the user requested. Therefore, through the Internet, the online rental platform may provide a much more efficient transaction platform for the users and the service providers that may never meet in a traditional pre-Internet transportation service system.

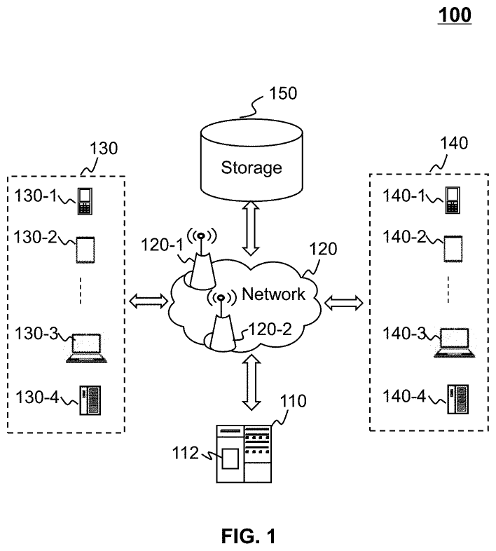

FIG. 1 is a schematic diagram illustrating an exemplary on-demand service system 100 according to some embodiments of the present disclosure. For example, the on-demand service system 100 may be an online transportation service platform for transportation services such as taxi hailing, chauffeur services, delivery vehicles, express car, carpool, bus service, driver hiring and shuttle services. The on-demand service system 100 may be an online platform including a server 110, a network 120, a requestor terminal 130, a provider terminal 140, and a storage 150. The server 110 may include a processing engine 112.

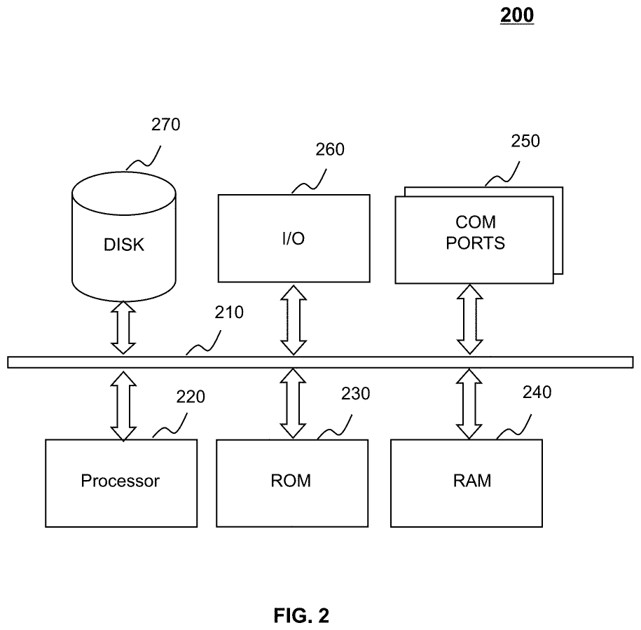

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the one or more user terminals (e.g., the one or more requestor terminals 130, provider terminals 140), and/or the storage 150 via the network 120. As another example, the server 110 may be directly connected to the one or more user terminals (e.g., the one or more requestor terminals 130, provider terminals 140), and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the plurality of service requests to perform one or more functions of the server 110 description in the present disclosure. For example, the processing engine 112 may determine a distribution mode for a plurality of service requests according to a genetic algorithm. In some embodiments, the processing engine 112 may include one or more processing engines (e.g., signal-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the on-demand service system 110 (e.g., the server 110, the one or more requestor terminals 130, provider terminals 140, or the storage 150) may transmit information and/data to other component(s) of the on-demand service system 100 via the network 120. For example, the server 110 may receive a service request from the requestor terminal 130 via the network 120. In some embodiments, the network 120 may be any type of wired or wireless network, or any combination thereof. Merely by way of example, the network 120 may include a cable network, a wireline network, an optical fiber network, a tele communications network, an intranet, an internet, a local area network (LAN), a wide area network (WAN), a wireless local area network (WLAN), a metropolitan area network (MAN), a wide area network (WAN), a public telephone switched network (PTSN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information between them.

In some embodiments, a service requestor may be a user of the requestor terminal 130. In some embodiments, the user of the requestor terminal 130 may be someone other than the service requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may use the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, the built-in device in the motor vehicle 130-4 may include an onboard computer, an onboard television, etc. In some embodiments, the requestor terminal 130 may be a device with positioning technology for locating the position of the service requestor and/or the requestor terminal 130.

In some embodiments, the provider terminal 140 may be similar to, or the same device as the requestor terminal 130. In some embodiments, the provider terminal 140 may be a device with positioning technology for locating the position of the driver and/or the provider terminal 140. In some embodiments, the requestor terminal 130 and/or the provider terminal 140 may communicate with other positioning device to determine the position of the service requestor, the requestor terminal 130, the driver, and/or the provider terminal 140. In some embodiments, the requestor terminal 130 and/or the provider terminal 140 may send positioning information to the server 110.

The storage 150 may store data and/or instructions. In some embodiments, the storage 150 may store data obtained from the one or more user terminals (e.g., the one or more passenger terminals 130, provider terminals 140). In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the on-demand service system 100 (e.g., the server 110, the requestor terminal 130, the provider terminal 140). One or more components of the on-demand service system 100 may access the data and/or instructions stored in the storage 150 via the network 120. In some embodiments, the storage 150 may be directly connected to or communicate with one or more components of the on-demand service system 100 (e.g., the server 110, the requestor terminal 130, the provider terminal 140). In some embodiments, the storage 150 may be part of the server 110.

In some embodiments, one or more components of the on-demand service system 100 (e.g., the server 110, the requestor terminal 130, the provider terminal 140) may access the storage 150. In some embodiments, one or more components of the on-demand service system 100 may read and/or modify information relating to the service requestor, provider, and/or the public when one or more conditions are met. For example, the server 110 may read and/or modify one or more users' information after a service. As another example, the provider terminal 140 may access information relating to the service requestor when receiving a service request from the requestor terminal 130, but the provider terminal 140 may not modify the relevant information of the service requestor.

In some embodiments, information exchanging of one or more components of the on-demand service system 100 may be achieved by way of requesting a service. The object of the service request may be any product. In some embodiments, the product may be a tangible product, or immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

One of ordinary skill in the art would understand that when an element of the on-demand service system 100 performs, the element may perform through electrical signals and/or electromagnetic signals. For example, when a requestor terminal 130 processes a task, such as making a determination, identifying or selecting an object, the requestor terminal 130 may operate logic circuits in its processor to process such task. When the requestor terminal 130 sends out a service request to the server 110, a processor of the service requestor terminal 130 may generate electrical signals encoding the service request. The processor of the requestor terminal 130 may then send the electrical signals to an output port. If the requestor terminal 130 communicates with the server 110 via a wired network, the output port may be physically connected to a cable, which may further transmit the electrical signals to an input port of the server 110. If the requestor terminal 130 communicates with the server 110 via a wireless network, the output port of the requestor terminal 130 may be one or more antennas, which may convert the electrical signals to electromagnetic signals. Similarly, a provider terminal 140 may process a task through operation of logic circuits in its processor, and receive an instruction and/or service request from the server 110 via electrical signals or electromagnet signals. Within an electronic device, such as the requestor terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 on which the server 110, the requestor terminals 130, or the provider terminals 140 may be implemented according to some embodiments of the present disclosure. For example, the processing engine 112 may be implemented on the computing device 200 and configured to perform functions of the processing engine 112 disclosed in this disclosure.

The computing device 200 may be used to implement any component of the on-demand service system 100 as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms to distribute the processing load.

The computing device 200, for example, may include COM ports 250 connected to and from a network connected thereto to facilitate data communications. The computing device 200 may also include a processor (e.g., a processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device 200 may include an internal communication bus 210, program storage and data storage of different forms including, for example, a disk 270, and a read only memory (ROM) 230, or a random access memory (RAM) 240, for various data files to be processed and/or transmitted by the computing device. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one processor is described in FIG. 2. Multiple processors are also contemplated, thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

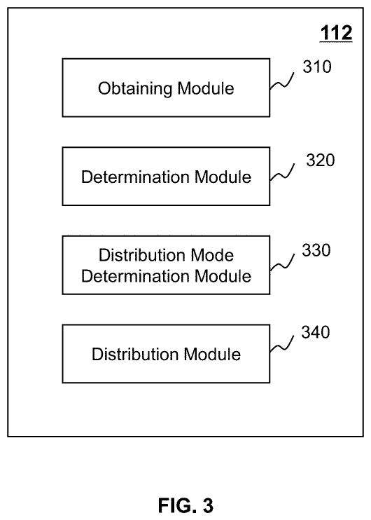

FIG. 3 is a block diagram illustrating an exemplary processing engine 112 according to some embodiments of the present disclosure. The processing engine 112 may include an obtaining module 310, a determination module 320, a distribution mode determination module 330, and a distribution module 340.

The obtaining module 310 may be configured to obtain a plurality of service requests. The obtaining module 310 may obtain the plurality of service requests from a plurality of requestor terminals 130 or a storage device (e.g., the storage 150) disclosed elsewhere in the present disclosure.

In some embodiments, the service request may be a request for a transportation service (e.g., a vehicle rental service). The service request may include a delivery time, a delivery location, a type of a vehicle, etc. As used herein, the delivery time may refer to a time point when a requestor wishes to receive the vehicle. The delivery location may refer to a location where the requestor wishes to receive the vehicle. The type of the vehicle may include an economy car, a luxury vehicle, a sport car, an off-road car, a commercial vehicle, etc.

The determination module 320 may be configured to determine one or more garages and/or one or more available service providers based on the plurality of service requests. As used herein, “garage” refers to any building, location, position, or a region where one or more vehicles can be housed or parked. For example, the determination module 320 may determine a target region including the plurality of delivery locations and determine one or more garages and/or one or more available service providers within the target region.

The distribution mode determination module 330 may be configured to determine a distribution mode for the plurality of service requests based on the one or more garages and the one or more available service providers. The distribution mode determination module 330 may determine the distribution mode according to a genetic algorithm, a hill climbing algorithm, a simulated anneal arithmetic, etc. As used herein, for each of the plurality of service requests, the processing engine 112 may determine a specific garage and a specific available service provider; for different service requests, the garages and/or the available service providers may be the same or different.

The distribution module 340 may be configured to distribute the plurality of service requests based on the distribution mode. The distribution module 340 may distribute the plurality of service requests to the one or more provider terminals 140 associated with the one or more available service providers. For example, the distribution module 340 may transmit information associated with the plurality of service requests to the one or more provider terminals 140 via one or more messages using any suitable communication protocol (e.g., the Hypertext Transfer Protocol (HTTP), Address Resolution Protocol (ARP), Dynamic Host Configuration Protocol (DHCP), File Transfer Protocol (FTP)).

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the obtaining module 310 and the determination module 320 may be combined as a single module which may both obtain the plurality of service requests and determine the one or more garages and/or the one or more available service providers. As another example, the processing engine 112 may include a storage module (not shown) used to store information and/or data (e.g., the delivery time, the delivery location, the type of the vehicle) associated with the plurality of service requests.

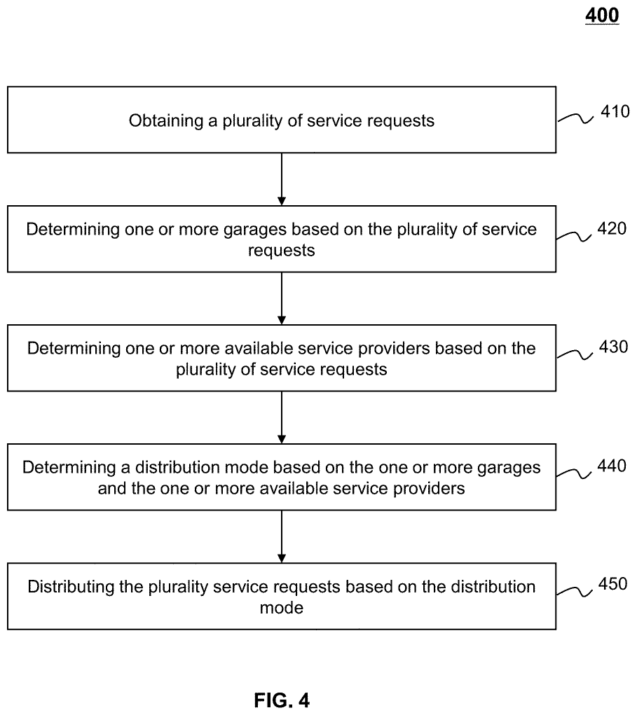

FIG. 4 is a flowchart illustrating an exemplary process 400 for distributing a plurality of service requests according to some embodiments of the present disclosure. In some embodiments, the process 400 may be implemented as a set of instructions (e.g., an application) stored in the storage ROM 230 or RAM 240. The processor 220 and/or the modules in FIG. 3 may execute the set of instructions, and when executing the instructions, the processor 220 and/or the modules may be configured to perform the process 400. The operations of the illustrated process present below are intended to be illustrative. In some embodiments, the process 400 may be accomplished with one or more additional operations not described and/or without one or more of the operations herein discussed. Additionally, the order in which the operations of the process as illustrated in FIG. 4 and described below is not intended to be limiting.

In 410, the processing engine 112 (e.g., the obtaining module 310) (e.g., the interface circuits of the processor 220) may obtain a plurality of service requests. The processing engine 112 may obtain the plurality of service requests from a plurality of requestor terminals or a storage device (e.g., the storage 150) disclosed elsewhere in the present disclosure.

In some embodiments, the service request may be a request for a transportation service (e.g., a vehicle rental service). The service request may include a delivery time, a delivery location, a type of a vehicle, etc. As used herein, the delivery time may refer to a time point when a requestor wishes to receive the vehicle. The delivery location may refer to a location where the requestor wishes to receive the vehicle. The type of the vehicle may refer to a type of vehicle the requestor wishes to receive and may include types such as but not limited to economy car, compact car, full-size car, sport-utility vehicle (SUV), luxury vehicle, sport car, off-road vehicle, commercial vehicle, a vehicle with a specific brand and/or year, etc.

In some embodiments, the plurality of service requests may be expressed as a first dataset illustrated as formula (1) below:

R={R₁,R₂,Rᵢ, . . . ,Rₙ} (1)

where Rᵢ refers to an ith service request and n refers to a number of the plurality of service requests.

In 420, the processing engine 112 (e.g., the determination module 320) (e.g., the processing circuits of the processor 220) may determine one or more garages based on the plurality of service requests.

In some embodiments, the processing engine 112 may determine the one or more garages based on a plurality of delivery locations and/or a plurality of vehicle types of the plurality of service requests. For example, the processing engine 112 may determine a target region including the plurality of delivery locations and determine one or more garages within the target region. In some embodiments, the processing engine 112 may determine a target region based on a travel time range that is decided by the delivery times and delivery locations of the plurality of service requests. The target region may be a city, a district, a geographic region within a certain radius from a predetermined center location, a geographic region within a certain travel time range from a predetermined center location, etc.

In some embodiments, the one or more garages may be expressed as a second dataset illustrated as formula (2) below:

A={A₁,A₂,Aⱼ, . . . ,Aₘ} (2)

where Aⱼ refers to an jth garage and m refers to a number of the one or more garages.

In 430, the processing engine 112 (e.g., the determination module 320) (e.g., the processing circuits of the processor 220) may determine one or more available service providers based on the plurality of service requests. As used herein, a service provider may be a person who can deliver the vehicle that the requestor requested from a first garage to the delivery location and/or send the vehicle to a second garage after the service request is completed (i.e., the use of the vehicle is ended), wherein the second garage may be the same as or different from the first garage. In some embodiments, the processing engine 112 may determine the one or more available service providers based on the delivery time, the delivery location, a service provider's current location, a service provider's current and expected availability, etc.

In some embodiments, the one or more available service providers may include a first service provider available to provide services at a first time point when the plurality of service requests are processed for distribution and/or a second service provider available to provide services at a second time point, wherein the second time point is within a time range from a time point when the plurality of service requests are processed for distribution to one or a plurality of delivery times of the plurality of service requests.

In some embodiments, the one or more available service providers may be expressed as a third dataset illustrated as formula (3) below:

B={B₁,B₂,Bₖ, . . . ,Bₚ} (3)

where Bₖ refers to a kth available service provider and p refers to a number of the one or more service providers.

In 440, the processing engine 112 (e.g., the distribution mode determination module 330) (e.g., the processing circuits of the processor 220) may determine a distribution mode for the plurality of service requests based on the one or more garages and the one or more available service providers. The processing engine 112 may determine the distribution mode according to a genetic algorithm, a hill climbing algorithm, a simulated anneal arithmetic, etc. In some embodiments, the processing engine 112 determine the distribution mode with a genetic algorithm, or any variations thereof.

As used herein, for each of the plurality of service requests, the processing engine 112 may determine a specific garage and a specific available service provider; for different service requests, the garages and/or the available service providers may be the same or different.

For example, the distribution mode may be expressed as a fourth dataset illustrated as formula (4) below:

C(A,B,R)={R₁:A₁,B₁,R₂:B₂, . . . ,Rᵢ:AₓB_{y}, . . . ,Rₙ:AᵤBᵥ} (4)

where C(A, B, R) refers to the distribution mode, AₓB_{y} refers to a combination of a garage Aₓ and an available service provider B_{y} corresponding to a service request Rᵢ, indicating that the available service provider B_{y} may provide service for the requestor who initiated the service request Rᵢ (i.e., deliver the vehicle that the requestor requested from the garage Aₓ to the delivery location of the service request Rᵢ).

In 450, the processing engine 112 (e.g., the distribution module 340) (e.g., the processing circuits of the processor 220) may distribute the plurality of service requests based on the distribution mode. In some embodiments, the processing engine 112 may distribute the plurality of service requests to one or more provider terminals 140 associated with the one or more available service providers. For example, the processing engine 112 may transmit information associated with the plurality of service requests to the one or more provider terminals 140 via one or more messages using any suitable communication protocol (e.g., the Hypertext Transfer Protocol (HTTP), Address Resolution Protocol (ARP), Dynamic Host Configuration Protocol (DHCP), File Transfer Protocol (FTP)). In some embodiments, the processing engine 112 may also send notices to the terminals of the service requestors regarding information such as but not limited to expected time of delivery, identification (e.g., plate number) of the vehicle to be delivered, etc.

It should be noted that the above description for distributing the plurality of service requests is merely provided for the purpose of illustration, and not intend to limit the scope of the present disclosure. For persons having ordinary skills in the art, multiple variations and modifications may be made under the teachings of the present disclosure. However, those variations and modifications do not depart from the present disclosure. For example, one or more other optional steps (e.g., a storing step) may be added elsewhere in the exemplary process 400. In the storing step, the processing engine 112 may store information and/or data (e.g., the delivery time, the delivery location, the type of the vehicle, the distribution mode) associated with the plurality of service requests in a storage device (e.g., the storage 150) disclosed elsewhere in the present disclosure. As another example, step 420 and step 430 may be combined as single step in which the processing engine 112 may both determine the one or more garages and the one or more available service providers.

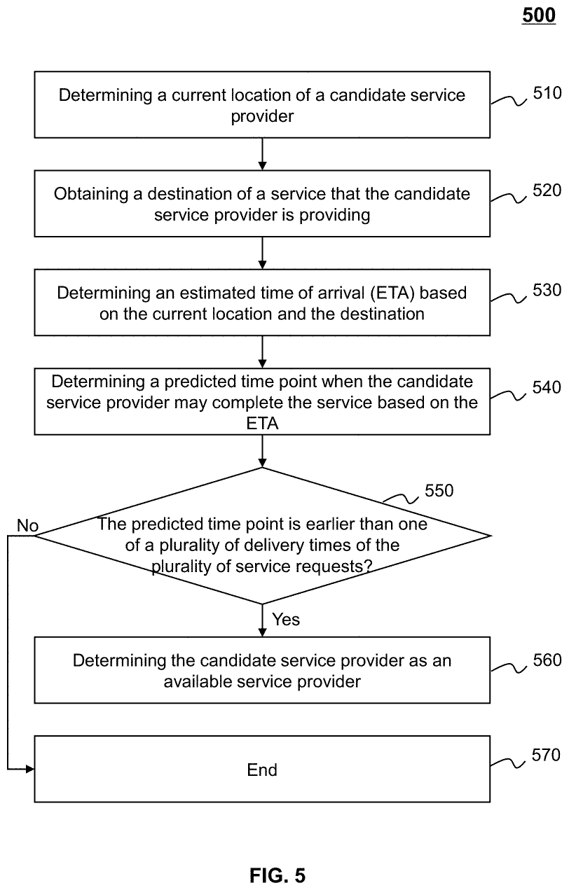

FIG. 5 is a flowchart illustrating an exemplary process 500 for determining an available service provider according to some embodiments of the present disclosure. In some embodiments, the process 500 may be implemented as a set of instructions (e.g., an application) stored in the storage ROM 230 or RAM 240. The processor 220 and/or the determination module 320 in FIG. 3 may execute the set of instructions, and when executing the instructions, the processor 220 and/or the determination module 320 may be configured to perform the process 500. The operations of the illustrated process present below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

As described in connection with step 430, the one or more available service providers may include a first service provider who is available to provide services at a first time point when the plurality of service requests are processed for distribution and/or a second service provider available to provide services at a second time point, wherein the second time point is within a time range from a time point when the plurality of service requests are processed for distribution to one of the plurality of delivery times of the plurality of service requests. In some embodiments, in order to determine the second service provider, the processing engine 112 may determine one or more candidate service providers and make one or more selections from the one or more candidate service providers as the second service provider(s) based on a predetermined condition according to the process 500 described below. In certain embodiments, the one or more available service providers may include only first service providers. In certain embodiments, the one or more available service providers may include only second service providers. In certain embodiments, the one or more available service providers may include a combination of first service providers and second service providers.

In 510, the processing engine 112 (e.g., the determination module 320) (e.g., the processing circuits of the processor 220) may determine a current location of a candidate service provider. In some embodiments, the candidate service provider may be a service provider who is providing a service (e.g., on the way to deliver a vehicle to a requestor, on the way to send a vehicle back to a garage) at the time point when the plurality of service requests are processed for distribution. The processing engine 112 may obtain the current location of the candidate service provider from the provider terminal 140 or a GPS device integrated in the vehicle being handled by the candidate service provider.

In 520, the processing engine 112 (e.g., the determination module 320) (e.g., the processing circuits of the processor 220) may obtain a destination of the service that the candidate service provider is providing. As described above, the destination may be a delivery location of a service request associated with the service or a location of the garage where the candidate service provider is sending back the vehicle.

In 530, the processing engine 112 (e.g., the determination module 320) (e.g., the processing circuits of the processor 220) may determine an estimated time of arrival (ETA) for the candidate service provider based on the current location and the destination. The processing engine 112 may determine the ETA based on a gradient boosting decision tree (GBDT) model, a generative adversarial network (GAN) mode, a convolutional neural network (CNN) model, etc.

In 540, the processing engine 112 (e.g., the determination module 320) (e.g., the processing circuits of the processor 220) may determine a predicted time point when the candidate service provider may complete the service based on the ETA. In some embodiments, the processing engine 112 may determine the predicted time point based on the ETA and a buffer time. As used herein, the buffer time may refer to a time interval during which the requestor needs to check the vehicle, a time interval during which the candidate service requestor needs to park the vehicle in a predetermined location in the garage, a compensation time for any accidental situation, etc. The buffer time may be default settings (e.g., 15 minutes) of the system 100 or may be adjustable under different situations.

In 550, the processing engine 112 (e.g., the determination module 320) (e.g., the processing circuits of the processor 220) may determine whether the predicted time point is earlier than one of the plurality of delivery times of the plurality of service requests. In some embodiments, the one of the plurality of delivery times refers to any one of the plurality of delivery times. In some embodiments, the one of the plurality of delivery times refers to a specific delivery time (e.g., the earliest, the medium, or the latest delivery time). In response to the determination that the predicted time point is earlier than one of the plurality of delivery times of the plurality of service requests, the processing engine 112 may determine the candidate service provider as an available service provider (i.e., a second service provider) in 560.

In some embodiments, in response to the determination that the predicted time point is later than all of the plurality of delivery times of the plurality of service requests, the processing engine 112 may execute the process 500 to 570 the end the process 500.

It should be noted that the above description for distributing the plurality of service requests is merely provided for the purpose of illustration, and not intend to limit the scope of the present disclosure. For persons having ordinary skills in the art, multiple variations and modifications may be made under the teachings of the present disclosure. However, those variations and modifications do not depart from the present disclosure.

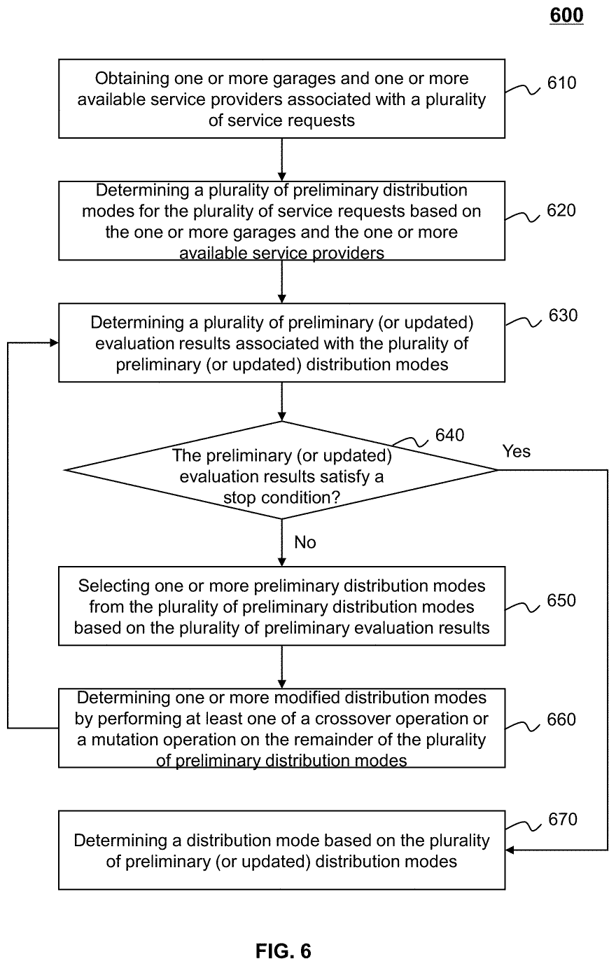

FIG. 6 is a flowchart illustrating an exemplary process 600 for determining a distribution mode for a plurality of service requests based on a genetic algorithm according to some embodiments of the present disclosure. In some embodiments, the process 600 may be implemented as a set of instructions (e.g., an application) stored in the storage ROM 230 or RAM 240. The processor 220 and/or the distribution mode determination module 330 in FIG. 3 may execute the set of instructions, and when executing the instructions, the processor 220 and/or the distribution mode determination module 330 may be configured to perform the process 600. The operations of the illustrated process present below are intended to be illustrative. In some embodiments, the process 600 may be accomplished with one or more additional operations not described and/or without one or more of the operations herein discussed. Additionally, the order in which the operations of the process as illustrated in FIG. 6 and described below is not intended to be limiting.

In 610, the processing engine 112 (e.g., the distribution mode determination module 330) (e.g., the processing circuits of the processor 220) may obtain one or more garages and one or more available service providers associated with a plurality of service requests. As described in connection with step 420 and/or step 430, the processing engine 112 may determine the one or more garages and the one or more available service providers based on a plurality of delivery locations, a plurality of delivery times, and/or a plurality of vehicle types associated with the plurality of service requests.

In 620, the processing engine 112 (e.g., the distribution mode determination module 330) (e.g., the processing circuits of the processor 220) may determine a plurality of preliminary distribution modes for the plurality of service requests based on the one or more of garages and the one or more available service providers. For example, the plurality of preliminary distribution modes may be expressed as a fifth dataset illustrated as formula (5) below:

M={C₁(A,B,R),C₂(A,B,R),C(A,B,R), . . . ,Cq(A,B,R)} (5)

where Cᵢ(A, B, R) refers to an Ith preliminary distribution mode, R refers to the first dataset including the plurality of service requests, A refers to the second dataset including the one or more garages, B refers to the third dataset including the one or more available service providers, and q refers to a number of the plurality of preliminary distribution modes. The number of the plurality of preliminary distribution modes may be default settings of the system 100, or may be adjustable under different situations. As described in connection with formula (4), each preliminary distribution mode includes a plurality of preliminary combinations associated with the plurality of service requests, and each of the plurality of combinations includes a specific garage and a specific available service provider.

In 630, the processing engine 112 (e.g., the distribution mode determination module 330) (e.g., the processing circuits of the processor 220) may determine a plurality of preliminary evaluation results associated with the plurality of preliminary distribution modes. In some embodiments, the processing engine 112 may evaluate the plurality of preliminary distribution modes based on a target function and a constraint condition associated with the target function to obtain the plurality of preliminary evaluation results.

In some embodiments, the target function may refer to an optimization goal associated with a global cost (e.g., a sum of a plurality of routes associated with the plurality of service requests, a sum of service times associated with the plurality of service requests) associated with the plurality of service requests. The target function may be a function associated with the one or more garages, the one or more available service providers, and the plurality of service requests. The constraint condition may be a condition which may be used to control a solution process of the target function. For example, the constraint condition may be expressed as formula (6) below:

Tₐₗ+Tₑₗ≤T_{d} (6)

where Tₐₗ refers to a time point when a specific service provider is available under the Ith preliminary distribution mode, T_{d} refers to a delivery time of a service request that is distributed to the specific service provider under the Ith preliminary distribution mode, and Tₑₗ refers to a service time during which the specific service provider can travel from a location where he/she may be available (i.e., a current location for the first service provider, or a destination of a service that the second service provider is providing) to a delivery location of the service request. For example, for the second service provider who is on the way to deliver a vehicle to a defined location by a requestor, Tₑₗ refers to a sum of a first time interval during which the second provider can travel from the defined location to a garage which is determined for the service request under the Ith preliminary distribution mode and a second time interval during which the second service provider can travel from the garage to the delivery location of the service request.

It should be noted that the constraint condition above is provided for illustration purposes, the processing engine 112 may also define various constraint conditions under different situations.

Take a specific preliminary distribution mode as an example, the processing engine 112 may determine whether the specific preliminary distribution mode satisfies the constraint condition. In response to the determination that the specific preliminary distribution mode satisfies the constraint condition, the processing engine 112 may evaluate the specific distribution mode according to formula (7) below:

E(l)=Σ₁ⁿdₗ(Rₗ,Cₗ(A,B,R)) (7)

where E(l) refers to an Ith preliminary evaluation result corresponding to the Ith preliminary distribution mode, Rᵢ refers to the ith service request, dᵢ refers to a route distance of the ith service request under the Ith preliminary distribution mode, and n refers to the number of the plurality of service requests.

Also take the specific preliminary distribution mode as an example, the processing engine 112 may evaluate the specific distribution mode according to formula (8) below:

E(l)=Σ₁ⁿtᵢ(Rᵢ,Cₗ(A,B,R)) (8)

where tᵢ refers to a service time (i.e., Tₑₗ illustrated in formula (6)) of the ith service request under the Ith preliminary distribution mode.

In 640, the processing engine 112 (e.g., the determination module 320) (e.g., the processing circuits of the processor 220) may determine whether the plurality of preliminary evaluation results satisfy a stop condition. As used herein, the stop condition may include a first condition that a number of iterations is larger than a first threshold (e.g., 3), a second condition that a difference between a minimum value of the plurality of preliminary evaluation results and an average value of the plurality of preliminary evaluation results is less than a second threshold, a third condition that the minimum value of the plurality of preliminary evaluation results is less than a third threshold, or the like, or a combination thereof.

In response to the determination that the plurality of preliminary evaluation results satisfy the stop condition, the processing engine 112 may execute the process 600 to step 670 to determine a distribution mode based on the plurality of preliminary distribution modes. For example, the processing engine 112 may select a preliminary distribution mode with the minimum value according to formula (7) or formula (8) as the distribution mode.

On the other hand, in response to the determination that the plurality of preliminary evaluation results do not satisfy the stop condition, the processing engine 112 may execute the process 600 to step 650 to select one or more preliminary distribution modes from the plurality of preliminary distribution modes based on the plurality of preliminary evaluation results. For example, the processing engine 112 may rank the plurality of preliminary distribution modes based on the plurality of preliminary evaluation results and select one or more (e.g., top 1, top 2, top 3, top 10) preliminary distribution modes based on the ranking.

In 660, the processing engine 112 (e.g., the distribution mode determination module 330) (e.g., the processing circuits of the processor 220) may determine one or more modified distribution modes by performing at least one of a crossover operation or a mutation operation on the remainder of the plurality of preliminary distribution modes. As used herein, the crossover operation may refer to a recombination and/or a replacement associated with information of two preliminary distribution modes. The mutation operation may refer to a modification associated with information of a preliminary distribution mode.

After determining the one or more modified distribution modes, the processing engine 112 may execute the process 600 back to step 630 to determine a plurality of updated evaluation results associated with the one or more selected preliminary distribution modes and the one or more modified distribution modes (collectively referred to as “updated distribution modes”). Further, the processing engine 112 may determine whether the plurality of updated evaluation results satisfy the stop condition. In response to the determination that the plurality of updated evaluation results satisfy the stop condition, the processing engine may execute the process 600 to step 670 to determine the distribution mode based on the updated distribution modes. On the other hand, in response to the determination that the plurality of updated evaluation results do not satisfy the stop condition, the processing engine 112 may still execute the process 600 to step 650 and/or 660 to determine further updated distribution modes. The iteration from step 630 through 670 may continue until the plurality of updated evaluation results satisfy the stop condition.

It should be noted that the above description for distributing the plurality of service requests is merely provided for the purpose of illustration, and not intend to limit the scope of the present disclosure. For persons having ordinary skills in the art, multiple variations and modifications may be made under the teachings of the present disclosure. However, those variations and modifications do not depart from the present disclosure.

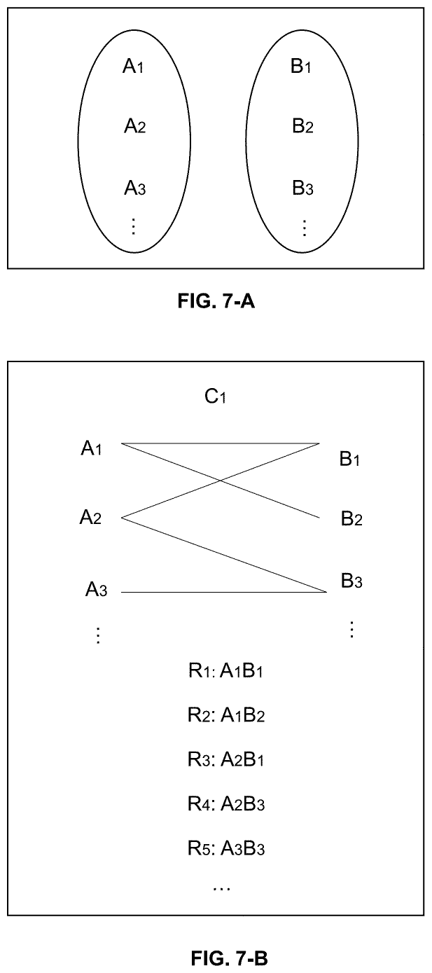

FIGS. 7-A and 7-B are schematic diagrams illustrating an exemplary preliminary distribution mode according to some embodiments of the present disclosure. As illustrated in FIG. 7-A, the processing engine 112 may determine a dataset A including one or more garages (e.g., A₁, A₂, A₃, . . . ) and a dataset B including one or more available service providers (e.g., B₁, B₂, B₃, . . . ) based on a plurality of service requests. As illustrated in FIG. 7-B, the processing engine 112 may determine a preliminary distribution mode C₁ for the plurality of service requests. Under the preliminary distribution mode C₁, a specific service request corresponds to a specific combination of a specific garage and a specific available service provider. For example, a service request R₁ corresponds to a combination of a garage A₁ and an available service provider B₁, a service request R₂ corresponds to a combination of a garage A₁ and an available service provider B₂, a service request R₃ corresponds to a garage A₂ and an available service provider B₁, etc.

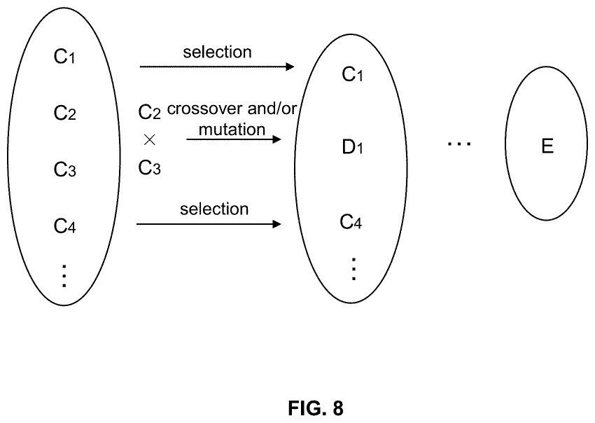

FIG. 8 is a schematic diagram illustrating an exemplary process for determining a distribution mode for a plurality of service requests based on a genetic algorithm according to some embodiments of the present disclosure. As illustrated, the processing engine 112 may determine a plurality of preliminary distribution modes (e.g., C₁, C₂, C₃, C₄, . . . ). Further, the processing engine 112 may select preliminary distribution modes C₁ and C₄, perform a crossover operation and/or a mutation operation on a preliminary distribution mode C₂ and a preliminary distribution mode C₃ to determine a modified distribution mode D₁, etc. The selected preliminary distribution modes C₁ and C₄ and the modified distribution mode D₁ may be collectively referred to as “updated distribution modes”. As described in connection with FIG. 6, the processing engine 112 may further iteratively perform the operations on the updated distribution modes until the evaluation results satisfy a stop condition. Finally, the processing engine 112 may determine a distribution mode E for the plurality of service requests.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Pen, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A system for distributing a plurality of service requests associated with an on-demand service, the system comprising:
at least one storage medium including a set of instructions;
at least one processor in communication with the at least one storage medium, wherein when executing the set of instructions, the at least one processor is configured to cause the system to:
obtain a plurality of service requests via a network;
determine one or more garages based on the plurality of service requests;
determine one or more available service providers based on the plurality of service requests;
determine a distribution mode for the plurality of service requests based on the one or more garages and the one or more available service providers according to a genetic algorithm; and
distribute the plurality of service requests based on the distribution mode.

2. The system of claim 1, wherein to determine the distribution mode for the plurality of service requests, the at least one processor is configured to cause the system further to:
determine a plurality of preliminary distribution modes for the plurality of service requests based on the one or more garages and the plurality of available service providers;
determine a plurality of preliminary evaluation results associated with the plurality of preliminary distribution modes;
determine whether the plurality of preliminary evaluation results satisfy a stop condition; and
determine the distribution mode based on the plurality of preliminary distribution modes in response to the determination that the plurality of preliminary evaluation results satisfy the stop condition.

3. The system of claim 2, wherein to determine the distribution mode for the plurality of service requests, the at least one processor is configured to cause the system further to:
in response to the determination that the plurality of preliminary evaluation results does not satisfy the stop condition,
select one or more preliminary distribution modes from the plurality of preliminary distribution modes based on the plurality of preliminary evaluation results;
determine one or more modified distribution modes by performing at least one of a crossover operation or a mutation operation on the remainder of the plurality of preliminary distribution modes other than the selected one or more preliminary distribution modes; and
update the plurality of preliminary evaluation results associated with the selected one or more preliminary distribution modes and the one or more modified distribution modes.

4. The system of claim 2, wherein the stop condition includes at least one of:
a first condition that a number of iterations is larger than a first threshold,
a second condition that a difference between a minimum value of the plurality of preliminary evaluation results and an average value of the plurality of preliminary evaluation results is less than a second threshold; or
a third condition that the minimum value of the plurality of preliminary evaluation results is less than a third threshold.

5. The system of claim 3, wherein to determine the plurality of preliminary evaluation results associated with the plurality of preliminary distribution modes, the at least one processor is configured to cause the system further to:
determine a target function associated with the one or more garages and the one or more available service providers;
determine a constraint condition associated with the target function; and
determine the plurality of preliminary evaluation results associated with the plurality of preliminary distribution modes based on the target function and the constraint condition.

6. The system of claim 1, wherein the one or more available service providers includes at least one first service provider available to provide services at a first time point when the plurality of service requests are processed for distribution.

7. The system of claim 1, wherein the one or more available service providers includes at least one second service provider available to provide services at a second time point, wherein the second time point is within a time range from a time point when the plurality of service requests are processed for distribution to one of a plurality of delivery times of the plurality of service requests.

8. The system of claim 7, wherein the at least one processor is configured to cause the system further to:
determine a current location of a candidate service provider;
obtain a destination of a service that the candidate service provider is providing;
determine an estimated time of arrival (ETA) based on the current location and the destination;
determine a predicted time point based on the ETA; and
in response to the determination that the predicted time point is earlier than one of the plurality of delivery times of the plurality of service requests, determine the candidate service provider as the second service provider.

9. The system of claim 1, wherein the service request is a request for renting a vehicle, and wherein the request includes at least one of a delivery time, a delivery location, or a type of the vehicle.

10. A method implemented on a computing device having at least one processor, at least one storage medium, and a communication platform connected to a network, the method comprising:
obtaining a plurality of service requests via a network;
determining one or more garages based on the plurality of service requests;
determining one or more available service providers based on the plurality of service requests;
determining a distribution mode for the plurality of service requests based on the one or more garages and the one or more available service providers according to a genetic algorithm; and
distributing the plurality of service requests based on the distribution mode.

11. The method of claim 10, wherein the determining a distribution mode for the plurality of service requests includes:
determining a plurality of preliminary distribution modes for the plurality of service requests based on the one or more garages and the plurality of available service providers;
determining a plurality of preliminary evaluation results associated with the plurality of preliminary distribution modes;
determining whether the plurality of preliminary evaluation results satisfy a stop condition; and
determining the distribution mode based on the plurality of preliminary distribution modes in response to the determination that the plurality of preliminary evaluation results satisfy the stop condition.

12. The method of claim 11, wherein the determining a distribution mode for the plurality of service requests includes:
in response to the determination that the plurality of preliminary evaluation results does not satisfy the stop condition,
selecting one or more preliminary distribution modes from the plurality of preliminary distribution modes based on the plurality of preliminary evaluation results;
determining one or more modified distribution modes by performing at least one of a crossover operation or a mutation operation on the remainder of the plurality of preliminary distribution modes other than the selected one or more preliminary distribution modes; and
updating the plurality of preliminary evaluation results associated with the selected one or more preliminary distribution modes and the one or more modified distribution modes.

13. The method of claim 11, wherein the stop condition includes at least one of:
a first condition that a number of iterations is larger than a first threshold,
a second condition that a difference between a minimum value of the plurality of preliminary evaluation results and an average value of the plurality of preliminary evaluation results is less than a second threshold; or
a third condition that the minimum value of the plurality of preliminary evaluation results is less than a third threshold.

14. The method of claim 12, wherein the determining a plurality of preliminary evaluation results associated with the plurality of preliminary distribution modes includes:
determining a target function associated with the one or more garages and the one or more available service providers;
determining a constraint condition associated with the target function; and
determining the plurality of preliminary evaluation results associated with the plurality of preliminary distribution modes based on the target function and the constraint condition.

15. The method of claim 10, wherein the one or more available service providers includes at least one first service provider available to provide services at a first time point when the plurality of service requests are processed for distribution.

16. The method of claim 10, wherein the one or more available service providers includes at least one second service provider available to provide services at a second time point, wherein the second time point is within a time range from a time point when the plurality of service requests are processed for distribution to one of a plurality of delivery times of the plurality of service requests.

17. The method of claim 16, wherein the method further includes:
determining a current location of a candidate service provider;
obtaining a destination of a service that the candidate service provider is providing;
determining an estimated time of arrival (ETA) based on the current location and the destination;
determine a predicted time point based on the ETA; and
in response to the determination that the predicted time point is earlier than the one of the plurality of delivery times of the plurality of service requests, determining the candidate service provider as the second service provider.

18. The method of claim 10, wherein the service request is a request for renting a vehicle, and wherein the request includes at least one of a delivery time, a delivery location, or a type of the vehicle.

19. A non-transitory computer readable medium, comprising at least one set of instructions for distributing a plurality of service requests associated with an on-demand service, wherein when executed by a processor, the at least one set of instructions directs the processor to perform acts of:
obtaining a plurality of service requests via a network;
determining one or more garages based on the plurality of service requests;
determining one or more available service providers based on the plurality of service requests;
determining a distribution mode for the plurality of service requests based on the one or more garages and the one or more available service providers according to a genetic algorithm; and
distributing the plurality of service requests based on the distribution mode.

20. The non-transitory computer readable medium of claim 19, wherein the service request is a request for renting a vehicle, and wherein the request includes at least one of a delivery time, a delivery location, or a type of the vehicle.
